(19) United States
(12) Patent Application Publication
(10) Pub. No.: US 2012/0169305 A1
(43) Pub. Date: Jul. 5, 2012

(54) MULTI-VOLTAGE REGULATOR

(75) Inventors: Yong Il KWON, Suwon (KR); Tah Joon Park, Suwon (KR); Koon Shik Cho, Seoul (KR)

(73) Assignee: SAMSUNG ELECTRO-MECHANICS., LTD.

(21) Appl. No.: 13/329,942

(22) Filed: Dec. 19, 2011

(30) Foreign Application Priority Data
Dec. 30, 2010 (KR) 10-2010-0139025

(51) Int. Cl. G05F 1/10

(52) U.S. Cl. 323/268

(57) ABSTRACT

Disclosed herein is a multi-voltage regulator. The multi-voltage regulator includes an error amplifier amplifying a difference voltage between a predetermined reference voltage and a received feedback voltage; a first voltage adjusting part connected to an output terminal of the error amplifier, the first voltage adjusting part regulating a level of a voltage at a power input terminal to output the regulated voltage to a first output terminal; a second voltage adjusting part connected to the output terminal of the error amplifier, the second voltage adjusting part regulating the level of the voltage at the power input terminal to output the regulated voltage to a second output terminal; and a voltage detector detecting a voltage according to a voltage at the first output terminal and a voltage at the second output terminal to supply the detected voltage as the feedback voltage.

### CROSS-REFERENCE TO RELATED APPLICATIONS

This application claims the priority of Korean Patent Application No. 10-2010-0139025, Dec. 30, 2010, in the Korean Intellectual Property Office, the disclosure of which is incorporated herein by reference.

### BACKGROUND OF THE INVENTION

1. Field of the Invention

The present invention relates to a multi-voltage regulator, and more particularly, to a multi-voltage regulator capable of outputting multiple voltages.

2. Description of the Related Art

In general, a regulator may be used in a power supply device supplying power to electronic devices including a memory, IC, or the like, in order to supply stable power. When a separate voltage is needed depending on a standby mode or an operating mode in order to reduce power consumption in this electronic device, the regulator may generate a multi-voltage to supply a necessary voltage.

A multi-voltage regulator according to the related art may employ a method of using an error amplifier and a plurality of MOSFETs (Metal Oxide Semiconductor Field Effect Transistors), or a method of using a switch at an output terminal in order to select a necessary voltage among multiple voltages outputted from the regulator.

However, the multi-voltage regulator according to the related art has defects in that output regulation may be deteriorated in the event in which an input voltage is varied at the time of generating the multi-voltage. In addition, according to the related art, the above method of using the switch at the output terminal in order to select the necessary voltage from the regulator has limitations in that the level of voltage may be dropped nearly to zero at the moment of switching, and in the case, when memory is applied thereto, memory data may be deleted.

### SUMMARY OF THE INVENTION

The present invention provides a multi-voltage regulator capable of outputting a stable multi-voltage by improving output regulation and reducing a voltage drop at the instant of selecting a necessary voltage.

According to an aspect of the present invention, there is provided a multi-voltage regulator, including: an error amplifier amplifying a difference voltage between a predetermined reference voltage and a received feedback voltage; a first voltage adjusting part connected to an output terminal of the error amplifier, the first voltage adjusting part regulating a level of a voltage at a power input terminal to output the regulated voltage to a first output terminal; a second voltage adjusting part connected to the output terminal of the error amplifier, the second voltage adjusting part regulating the level of the voltage at the power input terminal to output the regulated voltage to a second output terminal; and a voltage detector detecting a voltage according to a voltage at the first output terminal and a voltage at the second output terminal to supply the detected voltage as the feedback voltage.

The first voltage adjusting part may include a p-type channel MOSFET having a gate connected to the output terminal of the error amplifier, a source connected to the power input terminal, and a drain connected to the first output terminal.

The second voltage adjusting part may include a p-type channel MOSFET having a gate connected to the output terminal of the error amplifier, a source connected to the power input terminal, and a drain connected to the second output terminal.

The error amplifier may include an inverting input terminal receiving the reference voltage; a non-inverting input terminal to which the feedback voltage is inputted; and the output terminal connected to the first voltage adjusting part and the second voltage adjusting part.

The voltage detector may include a first resistor having one end connected to the first output terminal and the other end connected to a connection node between the error amplifier and the second output terminal; and a second resistor having one end connected to the first resistor and the other end connected to a ground, a voltage at a connection node between the first resistor and the second resistor being the received feedback voltage of the error amplifier.

The voltage detector may include a first n-type channel MOSFET having a gate and a drain connected to the first output terminal, and a source connected to a connection node between the error amplifier and the second output terminal; and a second n-type channel MOSFET having a gate and a drain connected to the source of the first n-type channel MOSFET, and a source connected to a ground, a connection node between the first n-type channel MOSFET and the second n-type channel MOSFET being connected to an input terminal of the error amplifier.

According to another aspect of the present invention, there is provided a multi-voltage regulator, including: an error amplifier amplifying a difference voltage between a predetermined voltage and a feedback voltage; a first voltage adjusting part connected to an output terminal of the error amplifier, the first voltage adjusting part regulating a level of a voltage at a power input terminal to output the regulated voltage to a first output terminal; a second voltage adjusting part connected to the output terminal of the error amplifier, the second voltage adjusting part regulating the level of the voltage at the power input terminal to output the regulated voltage to a second output terminal; a voltage detector detecting a voltage according to a voltage at the first output terminal and a voltage at the second output terminal to supply the detected voltage as the feedback voltage; a first reference voltage part generating a first reference voltage supplied to the error amplifier; a second reference voltage part generating a second reference voltage supplied to the error amplifier; and a reference voltage selector selecting any one of the first reference voltage and the second reference voltage to supply the selected voltage to the error amplifier.

The first and second reference voltage parts may generate a constant voltage regardless of a variation in the voltage at the power input terminal.

The first voltage adjusting part may include a p-type channel MOSFET having a gate connected to the output terminal of the error amplifier, a source connected to the power input terminal, and a drain connected to the first output terminal.

The second voltage adjusting part may include a p-type channel MOSFET having a gate connected to the output terminal of the error amplifier, a source connected to the power input terminal, and a drain connected to the second output terminal.

The error amplifier may includes an inverting input terminal receiving the reference voltage; a non-inverting input terminal to which the feedback voltage is inputted; and the output terminal connected to the first voltage adjusting part and the second voltage adjusting part.

The voltage detector may include a first resistor having one end connected to the first output terminal and the other end connected to a connection node between the error amplifier and the second output terminal; and a second resistor having one end connected to the first resistor and the other end connected to a ground, a voltage at a connection node between the first resistor and the second resistor being the feedback voltage of the error amplifier.

The voltage detector may include a first n-type channel MOSFET having a gate and a drain connected to the first output terminal, and a source connected to a connection node between the error amplifier and the second output terminal; and

a second n-type channel MOSFET having a gate and a drain connected to the source of the first n-type channel MOSFET, and a source connected to a ground, a connection node between the first n-type channel MOSFET and the second n-type channel MOSFET being connected to an input terminal of the error amplifier.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a multi-voltage regulator according to an embodiment of the present invention;

FIG. 2 is a circuit diagram of FIG. 1;

FIG. 3 is a block diagram of another example of a voltage detector in the multi-voltage regulator according to the embodiment of the present invention;

FIG. 4 is a diagram of a reference voltage part and a second reference voltage part in the multi-voltage regulator according to the embodiment of the present invention;

FIG. 5 is a circuit diagram of FIG. 4;

FIG. 6 is a timing chart showing the type of operating mode in a load to which the multi-voltage regulator according to the embodiment of the present invention supplies power, and a variation in supply voltage according to the type of operating mode; and

FIG. 7 is a block diagram of a multi-voltage regulator according to another embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Like reference numerals in the drawings denote like elements, and thus their description will be omitted.

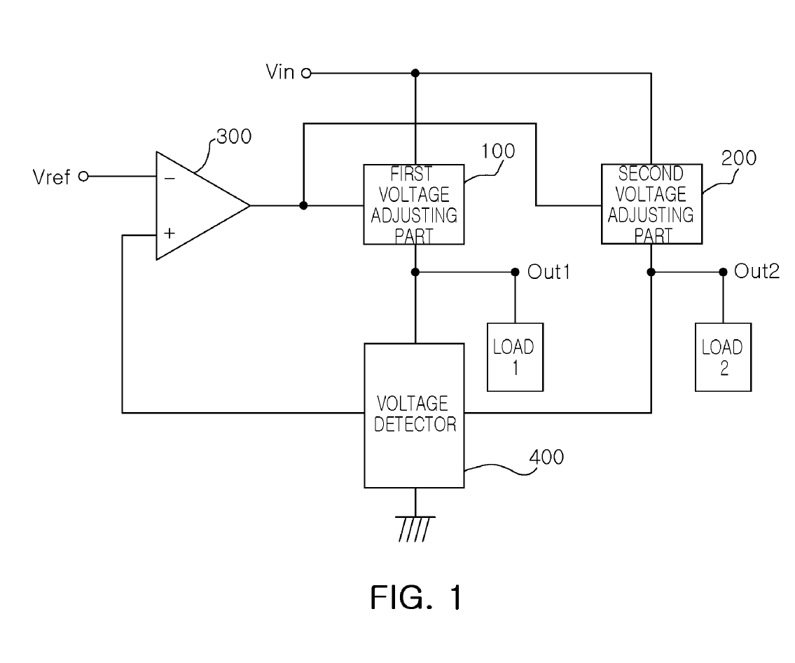

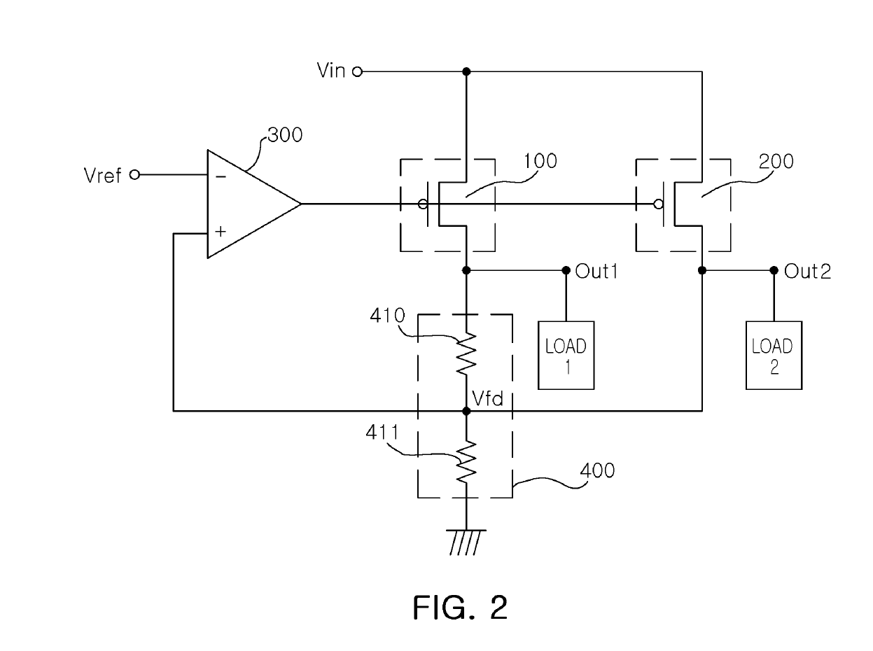

FIG. 1 is a block diagram of a multi-voltage regulator according to an embodiment of the present invention; and FIG. 2 is a detailed diagram of FIG. 1

Referring to FIG. 1, a multi-voltage regulator according to an embodiment of the present invention may include a first voltage adjusting part 100, a second voltage adjusting part 200, an error amplifier 300, and a voltage detector 400. Herein, a first output terminal Out1 may form a first feedback path together with the voltage detector 400 and the error amplifier 300. A second output terminal Out2 may form a second feedback path together with the voltage detector 400 and the error amplifier 300.

Referring to FIG. 2, the first voltage adjusting part 100 may regulate a level of a voltage Vin at a power input terminal to output the regulated voltage to the first output terminal Out1. In particular, the first voltage adjusting part 100 may include a p-type channel MOSFET (hereinafter, referred to as ‘PMOS’), in which a gate is connected to an output terminal of the error amplifier 300, a source is connected to the power input terminal, and a drain is connected to the first output terminal Out1 and a voltage detector 400.

The second voltage adjusting part 200 may regulate the level of the voltage Vin at the power input terminal to output the regulated voltage to the second output terminal Out2. In particular, the second voltage adjusting part 200 may include a PMOS, in which a gate is connected to the output terminal of the error amplifier 300, a source is connected to the power input terminal, and a drain is connected to the second output terminal Out2.

The error amplifier 300 may control voltage regulation of the first voltage adjusting part 100 and the second voltage adjusting part 200. In particular, the error amplifier 300 may be an amplifier having an inverting input terminal receiving a predetermined reference voltage, a non-inverting input terminal to which a voltage fed back through the first and second feedback loops is inputted, and an output terminal connected to the first regulator 100 and the second regulator 200.

The voltage detector 400 may detect a voltage fed back from the first output terminal Out1 to the error amplifier 300. In particular, the voltage detector 400 may include a first resistor 410 and a second resistor 411. As for the first resistor, one end is connected to the first output terminal Out1 and the other end is connected to a connection node between the error amplifier 300 and the second output terminal Out2. As for the second resistor 411, one end is connected to the first resistor 410 and the other end is connected to the ground. Herein, a voltage at a connection node of the first resistor 410, the second resistor 411, the error amplifier 300, and the second output terminal Out2 may be a voltage Vfd fed back to the error amplifier 300.

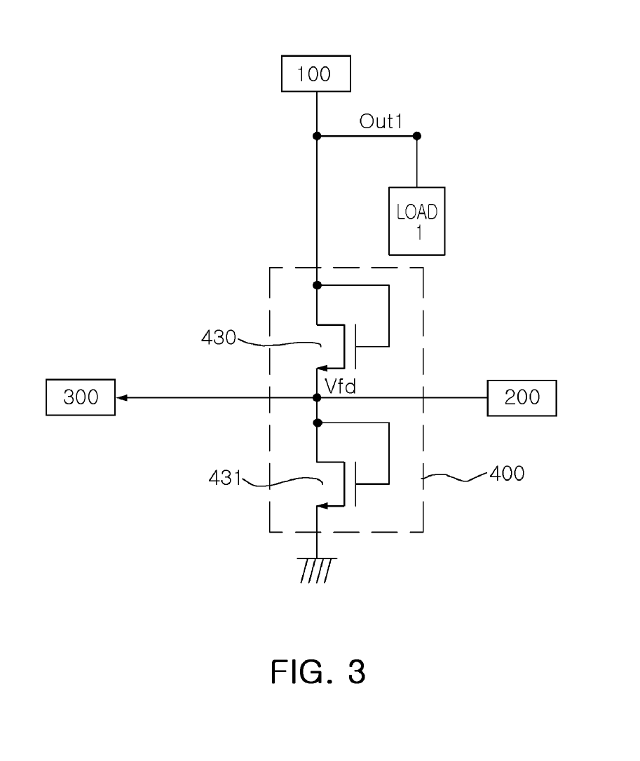

FIG. 3 shows another example of a voltage detector in a multi-voltage regulator according to an embodiment of the present invention.

Referring to FIG. 3, a voltage detector 400 may include a first n-type channel MOSFET 430 (hereinafter, referred to as “NMOS”) and a second NMOS 431. As for the first NMOS 430, a gate and a drain are connected to a first output terminal Out1, and a source is connected to a connection node between an error amplifier 300 and a second output terminal Out2. As for the second NMOS 431, a gate and a drain are connected to the source of the first NMOS 430, and a source is connected to the ground. Herein, a voltage at a connection node of the source of the first NMOS 430, the drain of the second NMOS, the error amplifier, and the second output terminal Out2 may be a voltage Vfd fed back to the error amplifier 300.

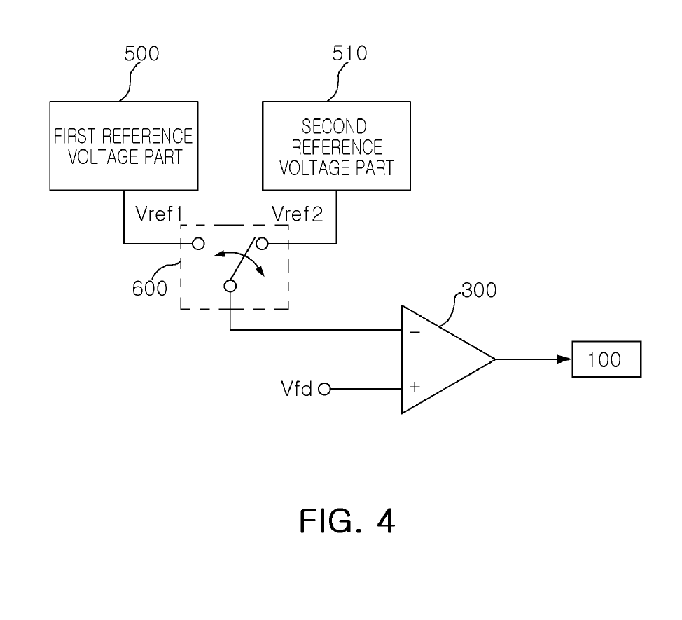

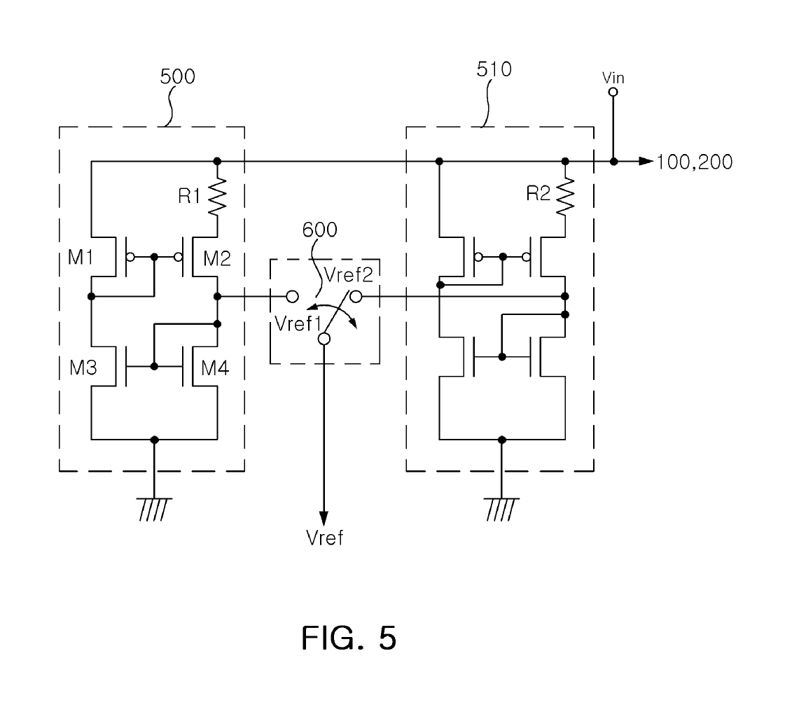

FIG. 4 shows a reference voltage part and a second reference voltage part in a multi-voltage regulator according to an embodiment of the present invention. FIG. 5 is a detailed diagram of FIG. 4

Referring to FIG. 4, the multi-voltage regulator according to the embodiment of the present invention may include a first reference voltage part 500, a second reference voltage part 510, and the reference voltage selector 600, in order to supply a reference voltage.

Referring to FIG. 5, the first reference voltage part 500 may generate a first reference voltage Vref1 from a voltage Vin at a power input terminal, and the second reference voltage part 510 may generate a second reference voltage Vref2 from the voltage Vin at the power input terminal. In particular, each of the first reference voltage part 500 and the second reference voltage part 510 may include a first PMOS M1, a second PMOS M2, a third PMOS M3, a fourth PMOS M1, and a resistor. As for the first PMOS M1, a source is connected to the power input terminal to which power is supplied, a gate is connected to a gate of the second PMOS M2, and a drain is connected to a drain of the third NMOS M3. Herein, the gate and the drain of the first PMOS M1 are connected to each other. One end of the resistor is connected to the first PMOS M1 and the power input terminal in parallel, and the other end of the resistor is connected to a source of the second PMOS M2.

As for the second PMOS M2, a source is connected to the other end of the resistor, a gate is connected to the gate of the first PMOS M1, and a drain is connected to a drain of the fourth NMOS M4 and a terminal of outputting the first reference voltage Vref1. As for the third NMOS M3, a drain is connected to the drain of the first PMOS M1, a gate is connected to a gate of the fourth NMOS M4, and a source is connected to the ground. As for the fourth NMOS M4, a drain is connected to the drain of the second PMOS M2 and the terminal of outputting the first reference voltage Vref1, a gate is connected to the gate of the third NMOS M3, and a source is connected to the ground. The drain and the gate of the fourth NMOS M4 are connected to each other. Herein, the third NMOS M3 and the fourth NMOS M4 may forms a current mirror structure.

The reference voltage selector 600 may select any one of the first reference voltage Vref1 generated in the first reference voltage part or the second reference voltage Vref2 generated in the second reference voltage part to supply the selected reference voltage to the inverting terminal of the error amplifier 300.

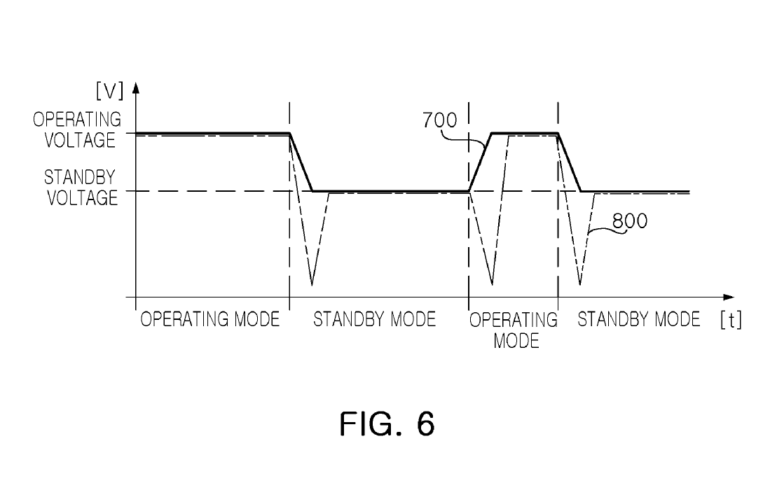

FIG. 6 is a timing chart showing the type of operating mode in a load to which a multi-voltage regulator according to an embodiment of the present invention supplies power, and variations in supply voltage according to the type of operating mode.

Referring to FIG. 6, a horizontal axis represents the change of operating mode and a vertical axis represents a level of an operating voltage or a standby voltage. A first waveform VW1 is a voltage waveform in the multi-voltage regulator according to the embodiment of the present invention, and a second waveform VW2 is a voltage waveform in a multi-voltage regulator according to the related art.

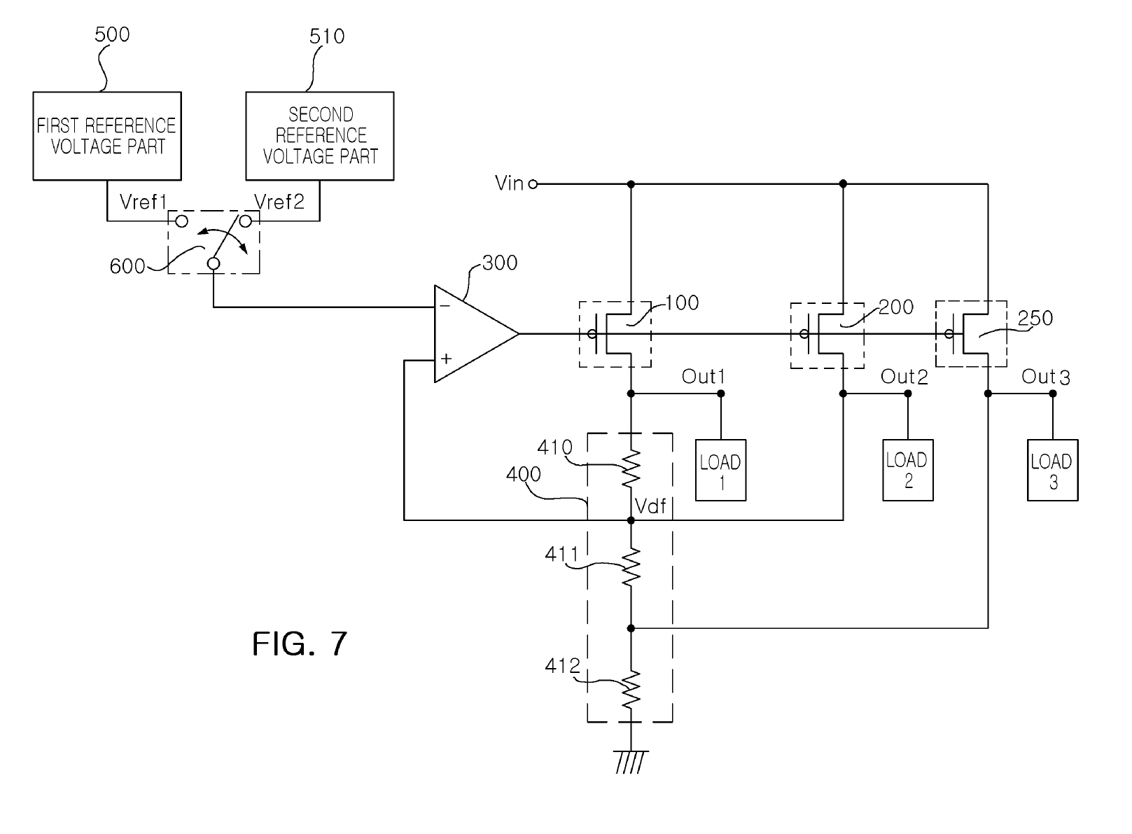

FIG. 7 shows a multi-voltage regulator according to another embodiment of the present invention.

Referring to FIG. 7, a multi-level regulator according to another embodiment of the present invention may further include a third voltage adjusting part 250. Herein, the voltage detector 400 may further include a third resistor 412 connected to a path through which an output of the third voltage adjusting part 250 is fed back, in addition to the constituents shown in FIG. 2.

The third voltage adjusting part 250 may regulate the level of the voltage Vin at the power input terminal to output the regulated voltage to a third output terminal Out3, like the first voltage adjusting part 100 and the second voltage adjusting part 200. In particular, the third voltage adjusting part 250 may include a PMOS in which a gate is connected to the output terminal of the error amplifier 300, a source is connected to the power input terminal, and a drain is connected to the third output terminal Out3.

The third resistor 412 of the voltage detector 400 may have one end connected to a connection node between the other end of the second resistor and the third output terminal, and the other end connected to the ground.

Hereinafter, the present invention will be described in detain based on operation and effect thereof with reference to the accompanying drawings.

The multi-voltage regulator according to the embodiment of the present invention will be described with reference to FIG. 1 and FIG. 2.

Referring to FIG. 1, the first voltage adjusting part 100 regulates the level of the voltage Vin at the power input terminal according to the output level of the error amplifier 300 to output a constant voltage to the first output terminal Out1.

Referring to FIG. 2, the first voltage adjusting part 100 may consist of the PMOS. The present embodiment will be described based on this premise.

In FIG. 2, the source of the PMOS receives the voltage Vin from the power input terminal. The drain of the PMOS is connected to the connection node between the first output Out1 and the voltage detector 400. The gate of the PMOS is connected to the output terminal of the error amplifier 300 to receive the amplified difference voltage between the feedback voltage Vfd and the reference voltage Vref.

For example, when the voltage at the power input terminal rises, the voltage at the first output terminal Out1 connected to the drain of the PMOS rises. Therefore, the feedback voltage Vfd detected by the voltage detector 400, also, rises further than the former state. The feedback voltage Vfd inputted to the non-inverting terminal of the error amplifier 300 rises, but the reference voltage inputted to the inverting terminal of the error amplifier 300 is constant. As a result, the voltage difference between both the terminals increases.

As the error amplifier 300 amplifies the voltage difference between input terminals, a level of the output of the error amplifier 300, which is inputted to the gate of the PMOS, increases further than the former state. As the gate voltage of the PMOS rises, the voltage at the first output terminal Out1 falls further than the former state. Therefore, even though the voltage Vin at the power input terminal is varied, the voltage outputted to the first output terminal Out1 through the PMOS controlled by the error amplifier 300 may be a stable voltage without a large variation.

The second voltage adjusting part 200, also, may stabilize the voltage at the second output terminal Out2, similarly to the operation principle of the first voltage adjusting part 100 as described above. This may be expressed by the following equation 1:

$$Out 1 = Vref \times ( \frac{R 1 + R 2}{R 2} - 0.5 \times \frac{R 1}{R 2} ) [ V ] \\ Out 2 = Vref [ V ] \qquad [ EQUATION 1 ]$$

Wherein, R1 means a resistance of the first resistor, R2 means a resistance of the second resistor, Vref means a reference voltage, and 0.5 means a constant value determined in consideration with feedback.

Referring the equation 1, stable output having a necessary level can be obtained by changing the resistances of the first resistor 410 and the second resistor 411 in the voltage detector 400.

Referring to FIG. 3, another example of the voltage detector 400 in the multi-voltage regulator according to the embodiment of the present invention will be described.

Referring to FIG. 3, the voltage detector 400 consists of the first NMOS 430 and the second NMOS 431, instead of the first resistor 410 and the second resistor 411 shown in FIG. 2. The first NMOS 430 has the gate and the drain connected to the first output terminal Out1, and the source connected to the connection node between the error amplifier 300 and the second output terminal Out2. The second NMOS 431 has the gate and the drain connected to the source of the first NMOS 430, and the source connected to the ground.

That is, the voltage detector 400 shown in FIG. 3 uses turn-on resistances of the transistors instead of the resistors, thereby reducing the overall size of the regulator even while obtaining the same effect.

The multi-voltage regulator according to the embodiment of the present invention will be described in reference with FIG. 2 and FIG. 4.

FIG. 2 and FIG. 4 show that the reference voltage inputted to the inverting terminal of the error amplifier 300 can be changed. The reference voltage selector 600 selects the first reference voltage Vref1 generated in the first reference voltage part 500 or the second reference voltage Vref2 generated in the second reference voltage part 510, according to the operating mode or the standby mode of the load, for the reference voltage inputted to the error amplifier 300.

For example, when the first reference voltage Vref1 generated in the first reference voltage part 500 and the second reference voltage Vref2 generated in the second reference voltage part 510 are respectively 1V and 1.4V, and the resistances of the first resistor 410 and the second resistor 411 of the voltage detector 400 are respectively 300 kΩ and 600 kΩ, the voltages at the first output terminal Out1 and the second output terminal Out2 in the first reference voltage Vref1 are respectively 1.25V and 0.1V, and the voltages at the first output terminal Out1 and the second output terminal Out2 in the second reference voltage Vref2 are respectively 1.75V and 1.4V, according to the equation 1.

Considering that an operating voltage is about 1.8V and a voltage required for memory data retention during a standby mode is not less than 1V in a normal memory, the above example may be applied such that the reference voltage selector 600 selects the second reference voltage Vref2 during the operating mode and the first reference voltage Vref1 during the standby mode while the voltage at the first output terminal Out1 is supplied to the memory. Herein, the voltage at the second output terminal Out2 may be supplied to another block of the load. As described above, the multi-voltage regulator according to the embodiment of the present invention is capable of supplying the voltage required for the operating mode and the standby mode through a single output terminal without a large drop in voltage by changing the reference voltage (described in description with reference to FIG. 6) even while supplying voltages to different loads through a plurality of output terminals.

Referring to FIG. 5, the first reference voltage part 500 and the second reference voltage part 510 has the same structure, which may be a band-gap reference circuit having a current mirror structure.

When the reference voltage supplied from the circuit shown in FIG. 5 is calculated, the reference voltage is expressed by the equation 2:

$$Vref = Vthn + \frac{2}{R \sqrt{{μ}_{n} \times {μ}_{p}} \times {C}_{ox} \times \sqrt{{W}_{4} / {L}_{4}}} \times ( \frac{1}{\sqrt{{W}_{1} / {L}_{1}}} - \frac{1}{\sqrt{{W}_{2} / {L}_{2 }}} ) \qquad [ EQUATION 2 ]$$

Wherein, μₙ means an electron mobility, μₚ means a hole mobility, Vthn means a threshold voltage of NMOS, Cox means a gate capacitance per unit area, W means a width of channel, L means a length of channel, and R means a resistance value.

The equation 2 shows that the reference voltage generated in each of the reference voltage parts is subordinate to a resistance of the resistor in which one end is connected to the first PMOS and the power input terminal in parallel and the other end is connected to the source of the second PMOS, and widths W and lengths L of respective channels of the first PMOS, the second PMOS, and the fourth NMOS. Therefore, this shows that the first reference voltage Vref1 can be generated regardless of the variation in the voltage at the power input terminal.

FIG. 6 shows voltage waveforms in the multi-voltage regulator according to the embodiment of the present invention and the multi-voltage regulator according to the related art, respectively, when a voltage is changed and supplied according to the standby mode and the operating mode, in an electronic device including a memory or the like.

In a case of the voltage waveform VW2 for the related art, the voltage drops nearly to zero at the instant of switching for selecting a necessary voltage. On the other hand, in a case of the voltage waveform VW1 for the embodiment of the present invention, the voltage does not drop largely even though a supply voltage is changed according to mode switching.

The multi-voltage regulator according to the related art selects one of voltages outputted from a plurality of output terminals by selecting one of the plurality of output terminals with a single reference voltage. Therefore, a time gap is necessarily made at the instant of output terminal switching, and this causes a large drop in voltage.

Whereas, the multi-voltage regulator according to the embodiment of the present invention, as shown in FIG. 4, includes a plurality of reference voltage parts. By changing the reference voltage parts, a necessary voltage required for the operating mode or the standby mode is supplied. Therefore, the embodiment of the present invention need not select the output terminal, like the related art, thereby preventing a large drop in voltage.

In particular, when the multi-voltage regulator according to the embodiment of the present invention supplies multiple voltages to the memory, a voltage does not drop largely at the time of voltage changing. Therefore, the present invention is capable of solving the problem of the related art in that the memory is likely to be deleted at the time of mode switching.

FIG. 7 shows that the multi-level regulator according to another embodiment of the present invention may further include the third voltage adjusting part 250 and the third resistor 412 of the voltage detector 400, thereby forming a feedback loop to realize a stabilized multi-voltage voltage additively. The third voltage adjusting part 250 consists of the PMOS having the gate connected to the output terminal of the error amplifier 300, the source connected to the power input terminal, and the drain connected to the third output terminal Out3. The third voltage adjusting part 250 regulates the level of the voltage Vin at the power input terminal to output the regulated voltage to the third output terminal Out3, like the first voltage adjusting part 100 and the second voltage regulator 200.

The voltage detector 400 further includes a third resistor in which one end is connected to the connection node between the other end of the second resistor and the third output and the other end is connected to the ground. A voltage Vfd fed back to the error amplifier has a different value from that the cases shown in FIG. 1 or FIG. 6, but the operation principles thereof are the same. Therefore, a detailed description regarding this will be omitted.

As described above, a multi-voltage regulator according to the present invention is capable of supplying a stable multi-voltage even though an input voltage is varied. In addition, the multi-voltage regulator according to the present invention is capable of preventing deletion of memory data caused by a rapid drop in voltage at the time of selecting a necessary voltage, when supplying multiple voltages to a memory or the like.

While the present invention has been shown and described in connection with the exemplary embodiments, it will be apparent to those skilled in the art that modifications and variations can be made without departing from the spirit and scope of the invention as defined by the appended claims.

What is claimed is:

1. A multi-voltage regulator, comprising:
an error amplifier amplifying a difference voltage between a predetermined reference voltage and a received feedback voltage;
a first voltage adjusting part connected to an output terminal of the error amplifier, the first voltage adjusting part regulating a level of a voltage at a power input terminal to output the regulated voltage to a first output terminal;
a second voltage adjusting part connected to the output terminal of the error amplifier, the second voltage adjusting part regulating the level of the voltage at the power input terminal to output the regulated voltage to a second output terminal; and
a voltage detector detecting a voltage according to a voltage at the first output terminal and a voltage at the second output terminal to supply the detected voltage as the feedback voltage.

2. The multi-voltage regulator of claim 1, wherein the first voltage adjusting part includes a p-type channel MOSFET having a gate connected to the output terminal of the error amplifier, a source connected to the power input terminal, and a drain connected to the first output terminal.

3. The multi-voltage regulator of claim 2, wherein the second voltage adjusting part includes a p-type channel MOSFET having a gate connected to the output terminal of the error amplifier, a source connected to the power input terminal, and a drain connected to the second output terminal.

4. The multi-voltage regulator of claim 1, wherein the error amplifier includes:
an inverting input terminal receiving the reference voltage;
a non-inverting input terminal to which the feedback voltage is inputted; and
the output terminal connected to the first voltage adjusting part and the second voltage adjusting part.

5. The multi-voltage regulator of claim 1, wherein the voltage detector includes:
a first resistor having one end connected to the first output terminal and the other end connected to a connection node between the error amplifier and the second output terminal; and
a second resistor having one end connected to the first resistor and the other end connected to a ground,
a voltage at a connection node between the first resistor and the second resistor being the received feedback voltage of the error amplifier.

6. The multi-voltage regulator of claim 1, wherein the voltage detector includes:
a first n-type channel MOSFET having a gate and a drain connected to the first output terminal, and a source connected to a connection node between the error amplifier and the second output terminal; and
a second n-type channel MOSFET having a gate and a drain connected to the source of the first n-type channel MOSFET, and a source connected to a ground,
a connection node between the first n-type channel MOSFET and the second n-type channel MOSFET being connected to an input terminal of the error amplifier.

7. A multi-voltage regulator, comprising:
an error amplifier amplifying a difference voltage between a predetermined voltage and a feedback voltage;
a first voltage adjusting part connected to an output terminal of the error amplifier, the first voltage adjusting part regulating a level of a voltage at a power input terminal to output the regulated voltage to a first output terminal;
a second voltage adjusting part connected to the output terminal of the error amplifier, the second voltage adjusting part regulating the level of the voltage at the power input terminal to output the regulated voltage to a second output terminal;
a voltage detector detecting a voltage according to a voltage at the first output terminal and a voltage at the second output terminal to supply the detected voltage as the feedback voltage;
a first reference voltage part generating a first reference voltage supplied to the error amplifier;
a second reference voltage part generating a second reference voltage supplied to the error amplifier; and
a reference voltage selector selecting anyone of the first reference voltage and the second reference voltage to supply the selected voltage to the error amplifier.

8. The multi-voltage regulator of claim 7, wherein the first and second reference voltage parts generate a constant voltage regardless of a variation in the voltage at the power input terminal.

9. The multi-voltage regulator of claim 7, wherein the first voltage adjusting part includes a p-type channel MOSFET having a gate connected to the output terminal of the error amplifier, a source connected to the power input terminal, and a drain connected to the first output terminal.

10. The multi-voltage regulator of claim 9, wherein the second voltage part includes a p-type channel MOSFET having a gate connected to the output terminal of the error amplifier, a source connected to the power input terminal, and a drain connected to the second output terminal.

11. The multi-voltage regulator of claim 7, wherein the error amplifier includes:
an inverting input terminal receiving the reference voltage;
a non-inverting input terminal to which the feedback voltage is inputted; and
the output terminal connected to the first voltage adjusting part and the second voltage adjusting part.

12. The multi-voltage regulator of claim 7, wherein the voltage detector includes:
a first resistor having one end connected to the first output terminal and the other end connected to a connection node between the error amplifier and the second output terminal; and
a second resistor having one end connected to the first resistor and the other end connected to a ground,
a voltage at a connection node between the first resistor and the second resistor being the feedback voltage of the error amplifier.

13. The multi-voltage regulator of claim 7, wherein the voltage detector includes:
a first n-type channel MOSFET having a gate and a drain connected to the first output terminal, and a source connected to a connection node between the error amplifier and the second output terminal; and
a second n-type channel MOSFET having a gate and a drain connected to the source of the first n-type channel MOSFET, and a source connected to a ground,
a connection node between the first n-type channel MOSFET and the second n-type channel MOSFET being connected to an input terminal of the error amplifier.
